(19) United States
(12) Patent Application Publication
(10) Pub. No.: US 2025/0156511 A1
(43) Pub. Date: May 15, 2025

(54) INFORMATION PROCESSING APPARATUS, INFORMATION PROCESSING METHOD, AND PROGRAM

(71) Applicant: Sony Group Corporation, Tokyo (JP)

(72) Inventors: Hiroki OGAWA, Tokyo (JP); Tadashi KAMOHARA, Tokyo (JP); Takashi NAKANO, Tokyo (JP)

(73) Assignee: Sony Group Corporation, Tokyo (JP)

(21) Appl. No.: 18/836,047

(22) PCT Filed: Feb. 7, 2023
(86) PCT No.: PCT/JP2023/003956

§ 371 Date: Aug. 6, 2024

(30) Foreign Application Priority Data
Feb. 24, 2022 (JP) 2022-026557

(51) Int. Cl. G06F 21/31

(52) U.S. Cl. CPC G06F 21/316

(57) ABSTRACT

A mobile terminal is a mobile information processing apparatus and includes an acquisition unit that acquires first behavior data indicating a behavior of an authorized user (U-v) and second behavior data indicating a behavior of a current user, and a function execution control unit that stops execution of a predetermined function in a case where the current user is not authenticated as the authorized user (U-v) by personal authentication referring the second behavior data to personal authentication information of the authorized user (U-v) generated based on the first behavior data when an execution permission request for the predetermined function is accepted.

### FIELD

The present disclosure relates to an information processing apparatus, an information processing method, and a program.

### BACKGROUND

In recent years, the spread of portable information processing apparatuses such as smartphones and tablet terminals is remarkable. In addition, these information processing apparatuses are mainly provided with a biometric authentication function such as fingerprint authentication or face authentication for personal authentication of an authorized user.

Such a biometric authentication function is useful from the viewpoint of security protection, but when executing a desired function such as electronic payment from the lock screen of the information processing apparatus, for example, the user is requested to perform a predetermined authentication operation such as touching the touch sensor or viewing the screen.

As one of biometric authentication methods for eliminating such inconvenience, a gait authentication method for performing personal authentication by a mode of a way of walking of a person, that is, a gait is known. As a technique using such a gait authentication method, there is a gate management system that images a gait of a person who is about to pass through a gate with a camera and determines whether or not the person is a registered person registered in advance (see, for example, Patent Literature 1.).

### CITATION LIST

### Patent Literature

Patent Literature 1: JP 2018-77552 A

### SUMMARY

### Technical Problem

However, the above-described conventional technology has room for further improvement in realizing simpler personal authentication.

For example, in the above-described conventional technique, when the gait authentication method is used, a camera for imaging the gait of a person as a third party is required, and thus there is a problem that the system becomes large in scale. On the other hand, in the case of using the fingerprint authentication method or the face authentication method, the predetermined authentication operation is requested as described above, which lacks convenience.

Therefore, the present disclosure proposes an information processing apparatus, an information processing method, and a program capable of realizing simpler personal authentication.

### Solution to Problem

In order to solve the above problems, one aspect of an information processing apparatus according to the present disclosure is a mobile information processing apparatus and includes an acquisition unit that acquires first behavior data indicating a behavior of an authorized user and second behavior data indicating a behavior of a current user, and a function execution control unit that stops execution of a predetermined function in a case where the current user is not authenticated as the authorized user by personal authentication referring the second behavior data to personal authentication information of the authorized user generated based on the first behavior data when an execution permission request for the predetermined function is accepted.

### BRIEF DESCRIPTION OF DRAWINGS

FIG. 1 is a schematic explanatory diagram (part 1) of an information processing method according to an embodiment of the present disclosure.

FIG. 2 is a schematic explanatory diagram (part 2) of an information processing method according to an embodiment of the present disclosure.

FIG. 3 is a block diagram illustrating a configuration example of a mobile terminal according to an embodiment of the present disclosure.

FIG. 4 is an explanatory diagram (part 1) of a gait data monitoring process.

FIG. 5 is an explanatory diagram (part 2) of a gait data monitoring process.

FIG. 6 is an explanatory diagram (part 3) of a gait data monitoring process.

FIG. 7 is an explanatory diagram (part 4) of a gait data monitoring process.

FIG. 8 is an explanatory diagram (part 5) of a gait data monitoring process.

FIG. 9 is an explanatory diagram of various functions that can be stopped by a function execution control unit.

FIG. 10 is a flowchart (part 1) illustrating a processing procedure executed by the mobile terminal.

FIG. 11 is a flowchart (part 2) illustrating a processing procedure executed by the mobile terminal.

FIG. 12 is an explanatory diagram (part 1) of gait authentication information according to a modification.

FIG. 13 is an explanatory diagram (part 2) of gait authentication information according to the modification.

FIG. 14 is a hardware configuration diagram illustrating an example of a computer that implements functions of the mobile terminal.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Furthermore, in the following description, it is assumed that the information processing apparatus according to the embodiment of the present disclosure is a mobile terminal 100 such as a smartphone carried by a user. Furthermore, hereinafter, the authorized user who uses the mobile terminal 100 is referred to as an “authorized user U-v”. In addition, hereinafter, a user other than the authorized user is referred to as an “unauthorized user U-i”.

Further, the present disclosure will be described according to the following order of items.
1. Overview
2. Configuration of mobile terminal
3. Modifications
4. Hardware configuration
5. Conclusion

### 1. OVERVIEW

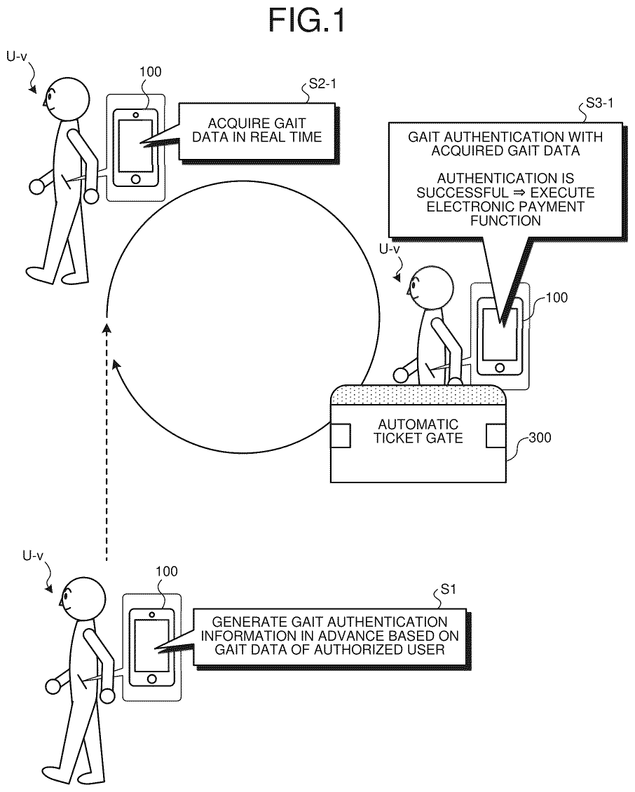

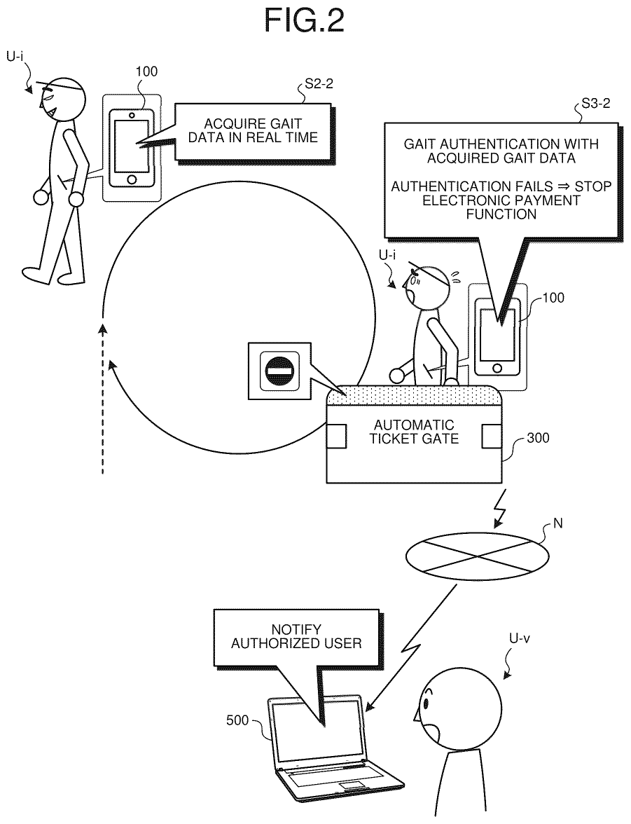

FIG. 1 is a schematic explanatory diagram (part 1) of an information processing method according to an embodiment of the present disclosure. Further, FIG. 2 is a schematic explanatory diagram (part 2) of an information processing method according to an embodiment of the present disclosure.

As described above, in the conventional technique, for example, when the gait authentication method is used, a camera for imaging the gait of a person as a third party is required, and thus there is a problem that the system becomes large in scale. On the other hand, for example, in the case of using the fingerprint authentication method or the face authentication method, the predetermined authentication operation is requested such as touching the touch sensor or viewing the screen as described above, which lacks convenience.

Therefore, in the information processing method according to an embodiment of the present disclosure, the first behavior data indicating a behavior of an authorized user U-v and the second behavior data indicating a behavior of a current user are acquired, personal authentication information of the authorized user U-v is generated based on the first behavior data, and the execution of a predetermined function is stopped in a case where the current user is not authenticated as the authorized user U-v by personal authentication referring the second behavior data to the personal authentication information when an execution permission request for the predetermined function is accepted.

Here, in the embodiment of the present disclosure, it is assumed that the first behavior data is the gait data of the authorized user U-v indicating the mode of the way of walking of the authorized user U-v. In addition, it is assumed that the second behavior data is gait data of the current user indicating the mode of the way of walking of the current user. Note that the current user refers to a user who is currently carrying the mobile terminal 100, and includes an unauthorized user U-i.

This will be described more specifically. As illustrated in FIG. 1, in the information processing method according to the embodiment of the present disclosure, first, the mobile terminal 100 generates the gait authentication information in advance based on the gait data of the authorized user U-v (Step S1). The gait data is sensor data by an acceleration sensor, a gyro sensor, or the like included in the mobile terminal 100.

The gait authentication information is personal authentication information of the authorized user U-v. The gait authentication information is generated as, for example, a deep neural network (DNN) learned using an algorithm such as deep learning. In a case where the gait authentication information is generated as such DNN, the gait authentication information outputs a probability that the current user corresponding to the gait data is the authorized user U-v in a case where the gait data is input.

Then, in the information processing method according to the embodiment of the present disclosure, after the generation of the gait authentication information, the mobile terminal 100 acquires the gait data in real time (Step S2-1). Then, in a case where the execution permission request for the predetermined function is accepted, the mobile terminal 100 executes the gait authentication with the acquired gait data (Step S3-1).

Note that the predetermined function is various functions that can be executed by the mobile terminal 100 from the lock screen, and is, for example, an electronic payment function in an automatic ticket gate 300 as illustrated in FIG. 1. In such a use case, the mobile terminal 100 accepts the execution permission request for the electronic payment function when the current user passes through the automatic ticket gate 300.

Then, as described in Step S3-1, when the current user is the authorized user U-v and the gait authentication is successful, the mobile terminal 100 executes the electronic payment function. As a result, the mobile terminal 100 can execute the electronic payment function without requesting the authorized user U-v to perform a predetermined authentication operation for personal authentication, that is, with high convenience.

On the other hand, as illustrated in FIG. 2, also in a case where the current user is the unauthorized user U-i, the mobile terminal 100 acquires the gait data in real time (Step S2-2). Then, in a use case similar to FIG. 1, for example, in a case where the execution permission request for the electronic payment function is accepted, the mobile terminal 100 executes the gait authentication with the acquired gait data (Step S3-2).

Then, as described in Step S3-2, if the gait authentication fails since the current user is the unauthorized user U-i, the mobile terminal 100 stops executing the electronic payment function. As a result, the mobile terminal 100 can prevent the unauthorized user U-i from illegally executing the electronic payment function.

In addition, the mobile terminal 100 notifies the authorized user U-v that the gait authentication of the unauthorized user U-i has failed and the execution of the requested function has been stopped in this manner (Step S4). As a result, the authorized user U-v can know that his/her mobile terminal 100 is about to be illegally used by the unauthorized user U-i.

In addition, at this time, the mobile terminal 100 notifies an other device 500, which is a notification destination registered in advance, via a network N such as the Internet or a mobile telephone network. Further, the mobile terminal 100 may also notify that it is about to be illegally used by the unauthorized user U-i with additional information about a current position or the like. As a result, the authorized user U-v can grasp, for example, the current position of the stolen mobile terminal 100 of the authorized user U-v.

Therefore, in the information processing method according to an embodiment of the present disclosure, the gait data of an authorized user U-v and the gait data of a current user are acquired, personal authentication information of the authorized user U-v is generated based on the gait data of the authorized user U-v, and an execution of a predetermined function is stopped in a case where the current user is not authenticated as the authorized user U-v by personal authentication referring the gait data of the current user to the personal authentication information when an execution permission request for the predetermined function is accepted.

Therefore, according to the information processing method according to the embodiment of the present disclosure, simpler personal authentication can be realized.

Note that, for example, even for the authorized user U-v, there is an aspect in which the gait data is likely to be different from the normal time due to a change in physical condition of the authorized user U-v. Furthermore, there is also an aspect in which the gait data is likely to be close to the gait data by the authorized user U-v if the way of walking is imitated by the unauthorized user U-i. In other words, the gait authentication method has an aspect that security strength is weaker than that of other biometric authentication methods such as fingerprint authentication and face authentication.

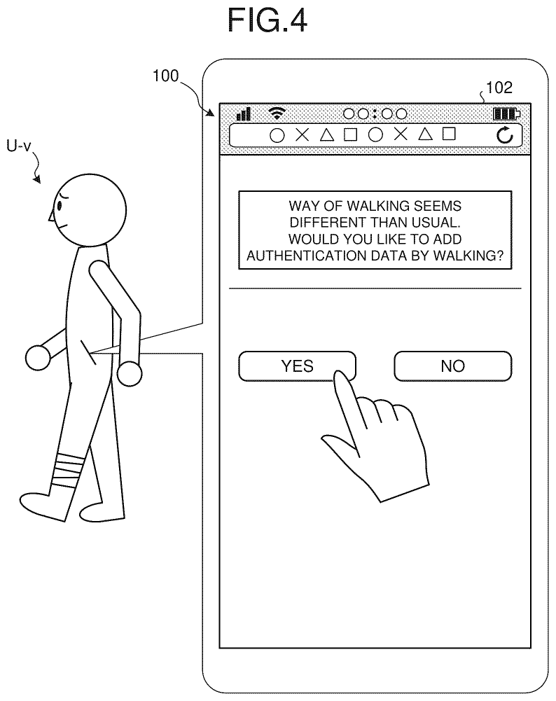

In order to compensate for this aspect, in the information processing method according to the embodiment of the present disclosure, the mobile terminal 100 monitors the gait data acquired in real time in comparison with the gait authentication information. Then, for example, in a case where the current user's gait data is different from usual, the mobile terminal 100 can add new gait data to the gait authentication information under the personal authentication of the authorized user U-v. As a result, it is possible to realize simpler personal authentication while reducing the influence of a change in physical condition or the like of the authorized user U-v. This point will be described later in detail with reference to FIGS. 4 to 8.

Hereinafter, a configuration example of the mobile terminal 100 to which the information processing method according to the embodiment of the present disclosure is applied will be described more specifically.

### 2. CONFIGURATION OF MOBILE TERMINAL

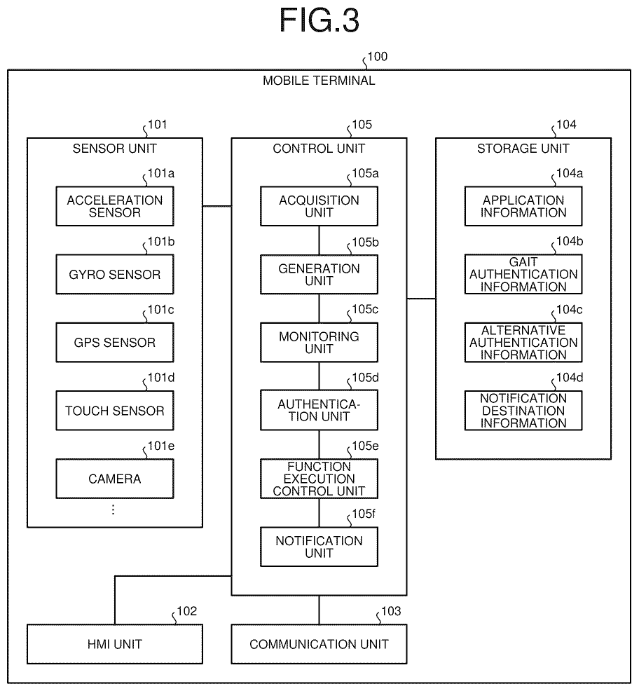

FIG. 3 is a block diagram illustrating a configuration example of the mobile terminal 100 according to an embodiment of the present disclosure. In FIG. 3, only components necessary for describing features of the embodiment of the present disclosure are illustrated, and description of general components is omitted.

In other words, the components illustrated in FIG. 3 are functionally conceptual and are not necessarily configured physically as illustrated. For example, the specific form of distribution and integration of each block is not limited to the one illustrated in the drawings, and all or a part thereof can be configured by functionally or physically distributing and integrating in any units according to various loads, usage conditions, and the like.

In the description using FIG. 3, the description of the already described components may be simplified or omitted.

The mobile terminal 100 is a computer used by the user to use a game application and various other applications, and is, for example, a smartphone or a tablet terminal. Note that the mobile terminal 100 may be a wearable device such as a smart watch, a mobile personal computer (PC), or the like.

As illustrated in FIG. 3, the mobile terminal 100 includes a sensor unit 101, a human machine interface (HMI) unit 102, a communication unit 103, a storage unit 104, and a control unit 105.

The sensor unit 101 is a group of various sensors mounted on the mobile terminal 100, and includes, for example, an acceleration sensor 101a, a gyro sensor 101b, a global positioning system (GPS) sensor 101c, a touch sensor 101d, and a camera 101e.

The acceleration sensor 101a is one of inertial sensors, and is a sensor that detects inertial force generated when a moving speed of the mobile terminal 100 changes, and outputs the inertial force as an acceleration as an electric signal.

The gyro sensor 101b is one of inertial sensors, is also referred to as an angular velocity sensor, and is a sensor that detects a change in rotation or direction of the mobile terminal 100 as an angular velocity using Coriolis force and outputs the angular velocity as an electric signal.

Sensor data that is the electric signal output from the acceleration sensor 101a and the gyro sensor 101b is acquired by the control unit 105 as gait data.

The GPS sensor 101c is a sensor that outputs the current position of the mobile terminal 100 by GPS positioning. The touch sensor 101d is a reading sensor of the fingerprint of the current user in a fingerprint authentication method as an alternative to the gait authentication method. The camera 101e is a sensor for reading a face of the current user in a face authentication method that is also an alternative to the gait authentication method.

The HMI unit 102 is a human-machine interface component including means for the current user and the mobile terminal 100 to exchange information, a device therefor, software, and the like, and is implemented by a liquid crystal touch panel, a speaker, and the like.

The communication unit 103 is implemented by, for example, a wireless communication module or the like. The communication unit 103 is wirelessly connected to the above-described network N, and transmits and receives information to and from the other device 500 via the network N.

The storage unit 104 is implemented by, for example, a semiconductor memory element, such as a random-access memory (RAM), a read only memory (ROM), a flash memory. In the example illustrated in FIG. 3, the storage unit 104 stores application information 104a, gait authentication information 104b, alternative authentication information 104c, and notification destination information 104d.

The application information 104a is information including programs of various application software corresponding to various functions in the mobile terminal 100, various parameters used at the time of execution of the programs, and the like.

The gait authentication information 104b is the personal authentication information of the authorized user U-v generated on the basis of the gait data output by the sensor unit 101 and acquired by the control unit 105. The gait authentication information 104b is generated, as described above, as DNN, for example, and outputs a probability that the current user corresponding to the gait data is the authorized user U-v in a case where the gait data is input.

The alternative authentication information 104c is personal authentication information that can be substituted for the gait authentication information 104b is generated on the basis of fingerprint data or face data output by the sensor unit 101 and acquired by the control unit 105.

The notification destination information 104d is information in which the other device 500 to be the notification destination is registered in advance when the authentication using the gait authentication fails.

The control unit 105 is a controller and is implemented by, for example, a central processing unit (CPU), a micro processing unit (MPU), or the like executing various program stored in the storage unit 104 with the RAM as a work area. Furthermore, the control unit 105 is implemented by, for example, an integrated circuit, such as an application specific integrated circuit (ASIC) or a field programmable gate array (FPGA).

The control unit 105 includes an acquisition unit 105a, a generation unit 105b, a monitoring unit 105c, an authentication unit 105d, a function execution control unit 105e, and a notification unit 105f, and implements or executes a function and an action of information processing described below.

The acquisition unit 105a acquires various types of sensor data including the gait data output from the sensor unit 101. The acquisition unit 105a acquires the gait data that the current user is carrying in real time.

The generation unit 105b generates the gait authentication information 104b and the alternative authentication information 104c on the basis of the various types of sensor data acquired by the acquisition unit 105a on the basis of the personal authentication of the authorized user U-v.

The monitoring unit 105c monitors whether or not the gait data is different from usual by comparing the gait data acquired in real time with the gait authentication information 104b. In other words, the monitoring unit 105c monitors whether there is a possibility of being the unauthorized user U-i on the basis of the gait data of the current user.

For example, the monitoring unit 105c inputs the gait data to the gait authentication information 104b in real time, and determines that there is a possibility of being the unauthorized user U-i in a case where the output probability of being the authorized user U-v is less than a predetermined threshold value.

Here, such a monitoring process will be described more specifically. FIGS. 4 to 8 are explanatory diagrams (part 1) to (part 5) of gait data to be monitored.

As illustrated in FIG. 4, it is assumed that the authorized user U-v has an injury or the like on the left foot, and the way of walking is different than usual.

In such a case, the monitoring unit 105c detects that the way of walking is different than usual on the basis of the gait data acquired in real time, and inquires whether or not to newly add the gait data for the gait authentication through the HMI unit 102 based on the estimation that the current user is the authorized user U-v as illustrated in FIG. 4. Here, it is assumed that the current user selects “Yes”.

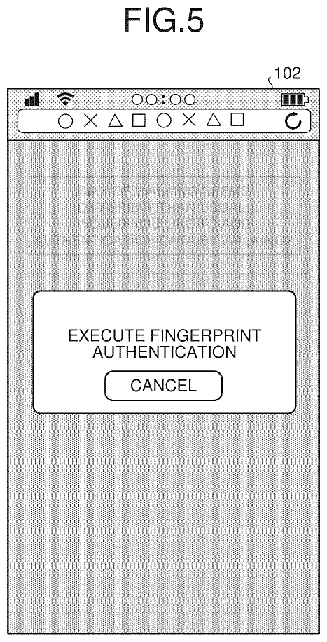

Then, as illustrated in FIG. 5, the monitoring unit 105c performs personal authentication of the current user by an authentication method substituted for the gait authentication method. In the example of FIG. 5, the monitoring unit 105c causes the current user to perform the personal authentication by the fingerprint authentication method. In such a case, the current user performs personal authentication via the touch sensor 101d described above. Needless to say, a face authentication method may be used.

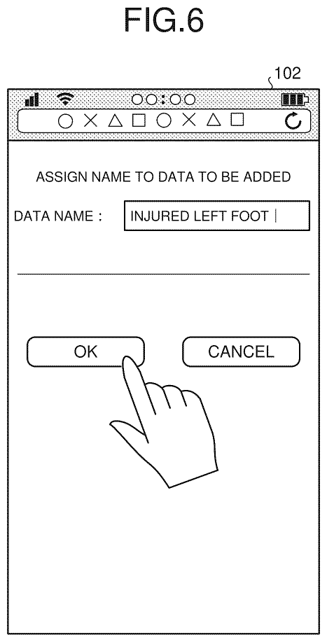

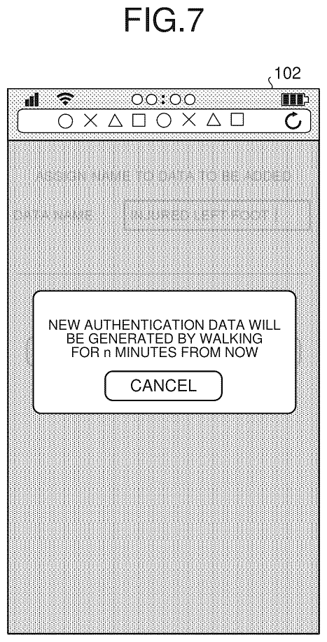

Then, when the personal authentication is performed, as illustrated in FIG. 6, the monitoring unit 105c causes the authorized user U-v who is the current user to assign a name to the data to be added, for example. Then, after making a name assigned, as illustrated in FIG. 7, the monitoring unit 105c displays a guidance such as “new authentication data will be generated by walking for n minutes from now”, and causes the acquisition unit 105a to start acquisition of gait data as new authentication data.

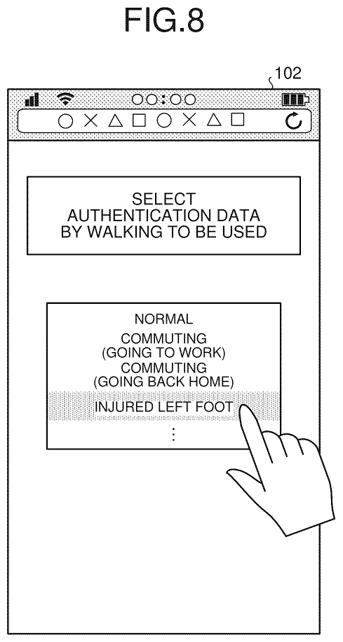

Then, the generation unit 105b adds the gait authentication information 104b corresponding to the gait data for n minutes. When the new gait authentication information 104b is added, as illustrated in FIG. 8, the authorized user U-v can select to use the newly added gait authentication information 104b. Thereafter, the mobile terminal 100 performs the gait authentication based on the gait authentication information 104b selected by the authorized user U-v.

Note that, as illustrated in FIG. 5, in newly adding the gait data for the gait authentication, the personal authentication of the authorized user U-v by the alternative authentication is assumed in order to secure the reliability of the gait authentication. Therefore, in the personal authentication in FIG. 5, it is preferable to use an authentication method having stronger security strength than the gait authentication method.

In addition, when the personal authentication fails in the scene of FIG. 5, the mobile terminal 100 preferably stops execution of various functions that can be executed from the lock screen and notifies the authorized user U-v of the stop, similarly to when the authentication using the gait authentication fails.

The description returns to FIG. 3. When accepting the execution permission request for a predetermined function, the authentication unit 105d performs personal authentication of referring the gait data of the current user to the gait authentication information 104b.

Specifically, when accepting the execution permission request for the electronic payment function or the like, the authentication unit 105d inputs the gait data of the current user, which is acquired in real time by the acquisition unit 105a before the acceptance of the request, to the gait authentication information 104b.

Then, the authentication unit 105d authenticates that the current user is the authorized user U-v in a case where the probability, which is output from the gait authentication information 104b, that the current user is the authorized user U-v is greater than or equal to a predetermined threshold value. On the other hand, the authentication unit 105d does not authenticate that the current user is the authorized user U-v in a case where the probability is lower than the predetermined threshold value.

In a case where the current user is authenticated as the authorized user U-v by the authentication unit 105d, the function execution control unit 105e executes the function corresponding to the accepted request. Further, in a case where the current user is not authenticated as the authorized user U-v by the authentication unit 105d, the function execution control unit 105e stops execution of the function corresponding to the accepted request.

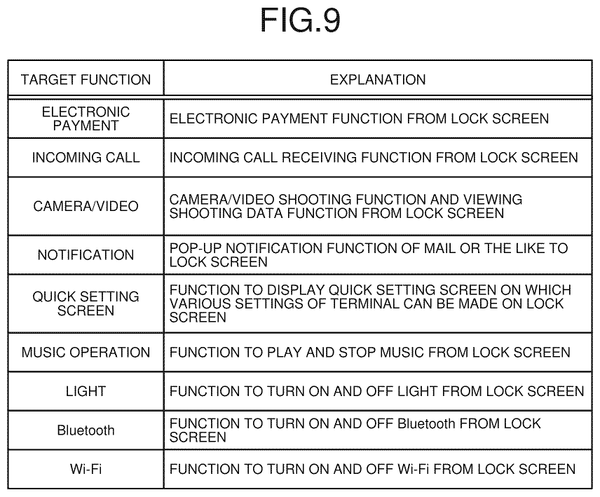

Here, FIG. 9 is an explanatory diagram of various functions that can be stopped by the function execution control unit 105e. As illustrated in FIG. 9, the function execution control unit 105e can stop execution of various functions that can be executed the authorized user U-v from the lock screen of the mobile terminal 100 when the authentication using the gait authentication fails.

As illustrated in FIG. 9, the target functions include an incoming call, a camera/video, a notification, a quick setting screen, a music operation, a light, Bluetooth (registered trademark), Wi-Fi (registered trademark), and the like in addition to the electronic payment described above.

The quick setting screen is a screen that can be displayed by a swipe operation or the like from the upper part, the lower part, or the like of the liquid crystal touch panel. In addition, the music operation, the light, Bluetooth, Wi-Fi, or the like may be executable from the quick setting screen.

The function execution control unit 105e can disable the display of the entire quick setting screen when the authentication using the gait authentication fails. In addition, although the function execution control unit 105e can display the quick setting screen, it is also possible to individually disable various functions that can be executed from the quick setting screen.

The description returns to FIG. 3. In a case where the authentication using the gait authentication fails and the execution of the requested function is stopped, the notification unit 105f notifies the other device 500 registered in the notification destination information 104d of the fact.

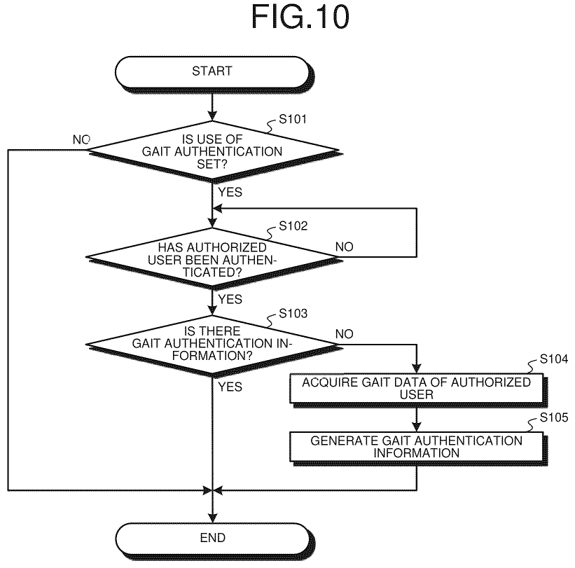

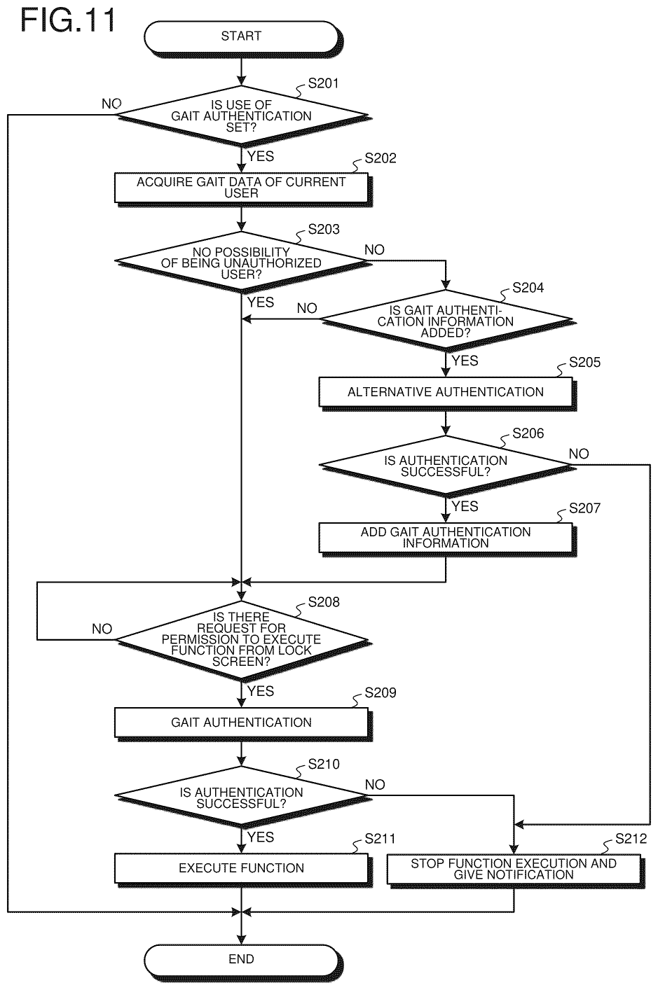

Next, a procedure of processing executed by the mobile terminal 100 will be described using FIGS. 10 and 11. FIGS. 10 and 11 are flowcharts (part 1) and (part 2) illustrating procedures of processing executed by the mobile terminal 100.

First, FIG. 10 illustrates a processing procedure in a case where the gait authentication information 104b is generated in advance. In such a case, as illustrated in FIG. 10, the control unit 105 confirms whether or not the use of the gait authentication indicating the gait authentication is used in the mobile terminal 100 is set (Step S101).

If the use of the gait authentication is set (Step S101, Yes), the control unit 105 confirms whether or not the authorized user U-v has been authenticated (Step S102). If the authorized user U-v has been authenticated (Step S102, Yes), the control unit 105 determines whether or not there is already the gait authentication information (Step S103). If there is the gait authentication information (Step S103, Yes), the processing is terminated.

On the other hand, if there is no gait authentication information (Step S103, No), the acquisition unit 105a acquires the gait data of the authorized user U-v (Step S104), and the generation unit 105b generates the gait authentication information 104b on the basis of the gait data (Step S105). Then, the processing ends.

Note that, if the authorized user U-v has not been authenticated (Step S102, No), the control unit 105 repeats Step S102. In addition, if the use of the gait authentication is not set (Step S101, No), the processing ends.

Next, FIG. 11 illustrates a processing procedure after the generation of the gait authentication information 104b. As illustrated in FIG. 11, the control unit 105 confirms whether or not the use of the gait authentication indicating the gait authentication is used in the mobile terminal 100 is set (Step S201).

If the use of the gait authentication is set (Step S201, Yes), the acquisition unit 105a acquires the gait data of the current user (Step S202). Then, the monitoring unit 105c monitors whether there is a possibility of being an unauthorized user U-i (Step S203). If there is no possibility of being the unauthorized user U-i (Step S203, Yes), the process proceeds to Step S208. If there is a possibility of being the unauthorized user U-i (Step S203, No), the monitoring unit 105c inquires of the current user whether or not to add the gait authentication information 104b (Step S204).

Here, in a case where the gait authentication information 104b is added (Step S204, Yes), the authentication unit 105d performs the alternative authentication using the alternative authentication information 104c (Step S205), and if the authentication is successful (Step S206, Yes), the gait authentication information 104b is added (Step S207), and the process proceeds to Step S208.

If the authentication fails (Step S206, No), the process proceeds to step S212. Note that in a case where the gait authentication information 104b is not added (Step S204, No), the process proceeds to Step S208.

In Step S208, the control unit 105 determines whether or not there is a request for permission to execute a function from the lock screen (Step S208). If there is no such request (Step S208, No), Step S208 is repeated.

If there is a request (Step S208, Yes), the authentication unit 105d executes the gait authentication based on the gait data of the current user (Step S209). Then, if the authentication is successful (Step S210, Yes), the function execution control unit 105e executes the function corresponding to the request (Step S211). Then, the processing ends.

On the other hand, if the authentication fails (Step S210, No), the function execution control unit 105e stops execution of the function corresponding to the request, and the fact is notified by the notification unit 105f (Step S212). Then, the processing ends.

Note that if the use of the gait authentication is not set (Step S201, No), the processing ends as it is. In such a case, the personal authentication is performed by an authentication method other than the gait authentication method.

### 3. MODIFICATIONS

Meanwhile, the embodiment of the present disclosure described above can include several modifications.

For example, in the embodiment of the present disclosure, the gait authentication information 104b is a DNN, but the configuration of the learning model learned by machine learning is not limited. For example, an algorithm other than deep learning may be used as the machine learning algorithm. For example, machine learning may be executed by a regression analysis method such as support vector regression using a pattern identifier such as a support vector machine (SVM), and the gait authentication information 104b may be learned. Furthermore, here, the pattern identifier is not limited to the SVM, and may be, for example, AdaBoost.

Furthermore, the gait authentication may be performed by collating the gait data of the current user with the walking pattern indicated by the gait data of the authorized user U-v included in the gait authentication information 104b by a pattern matching method regardless of the machine learning algorithm.

Note that the walking pattern of the authorized user U-v may include a plurality of walking patterns depending on a walking route, for example. Therefore, by collating a combination of the plurality of walking patterns, the strength of security based on the gait authentication may be increased.

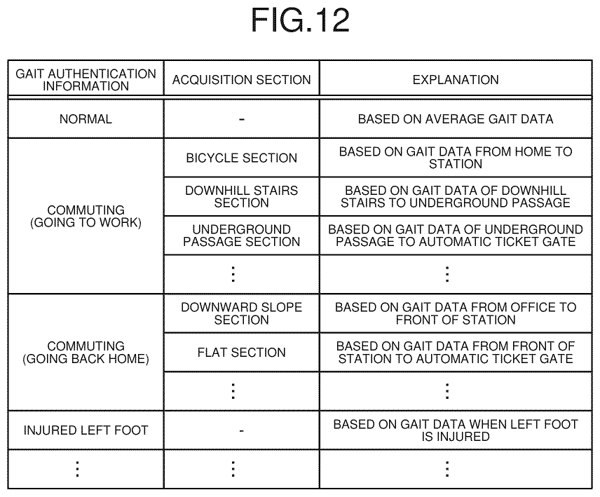

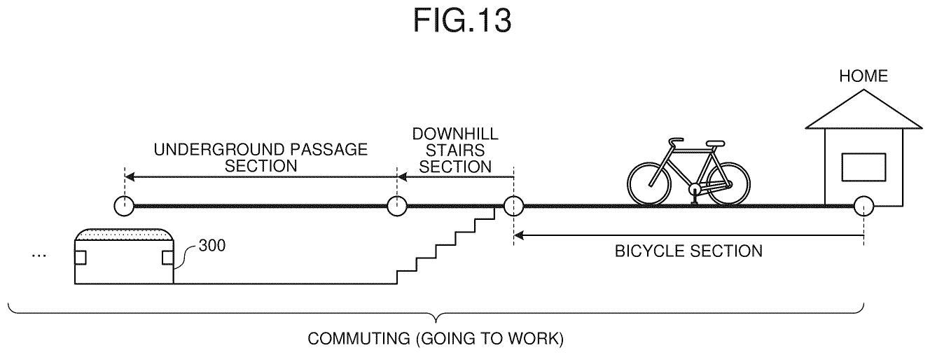

FIG. 12 is an explanatory diagram (part 1) of the gait authentication information 104b according to a modification. Further, FIG. 13 is an explanatory diagram (part 2) of the gait authentication information 104b according to a modification. Note that FIG. 12 corresponds to options of the gait authentication information 104b illustrated in FIG. 8.

As illustrated in FIG. 12, the gait authentication information 104b may be selectable according to the situation of the authorized user U-v as illustrated in FIG. 8. Furthermore, as illustrated in commuting (going to work) or commuting (going back home) of FIG. 12, the gait authentication information 104b may include a plurality of walking patterns.

Referring to the commuting (going to work) as an example, the gait authentication information 104b includes a plurality of walking patterns indicated by the respective gait data of a bicycle section, a downhill stairs section, and an underground passage section as illustrated in FIGS. 12 and 13.

Although the bicycle section cannot be strictly said to be a walking pattern, the behavior data by the acceleration sensor 101a and the gyro sensor 101b acquired in the bicycle section can be handled in the same manner as the gait data.

Then, if the authorized user U-v usually passes through the automatic ticket gate 300 through such a walking pattern at the time of going to work, the authentication unit 105d may execute the authentication process on the basis of a combination of the plurality of walking patterns.

In such a case, the authentication does not succeed unless the unauthorized user U-i passes through the automatic ticket gate 300 through at least a plurality of walking patterns similar to those of the authorized user U-v. Therefore, even if the unauthorized user U-i imitates the way of walking of the authorized user U-v, it is difficult to succeed in the authentication. As a result, it is possible to increase the strength of security by the gait authentication.

In addition, a configuration example in which the system is completed only by the mobile terminal 100 without being enlarged has been described so far, but a configuration including a server device connected to the mobile terminal 100 via a network may be employed.

For example, the server device may generate and authenticate the personal authentication information. In such a case, the generation unit 105b of the mobile terminal 100 transmits the gait data of the authorized user U-v acquired from the sensor unit 101 to the server device, causes the server device to generate the gait authentication information 104b on the basis of the gait data, and causes the storage unit included in the server device to store the gait authentication information 104b. Then, when the authentication unit 105d of the mobile terminal 100 accepts a request for permission to execute a predetermined function from the current user, the gait data of the current user is transmitted to the server device, and the server device is caused to perform personal authentication referring the gait data of the current user to the gait authentication information 104b. Then, the mobile terminal 100 performs subsequent processing on the basis of the authentication result in the server device.

Furthermore, for example, the server device may perform authentication after the mobile terminal 100 generates the personal authentication information. In such a case, the generation unit 105b of the mobile terminal 100 generates the gait authentication information 104b on the basis of the gait data of the authorized user U-v acquired from the sensor unit 101, sends the gait authentication information 104b to the server device, and causes the storage unit included in the server device to store the gait authentication information 104b. Then, when the authentication unit 105d of the mobile terminal 100 accepts a request for permission to execute a predetermined function from the current user, the gait data of the current user is transmitted to the server device, and the server device is caused to perform personal authentication referring the gait data of the current user to the gait authentication information 104b. Then, the mobile terminal 100 performs subsequent processing on the basis of the authentication result in the server device.

If only the server device stores the gait authentication information 104b, there is a possibility that the personal authentication cannot be performed in a case where the mobile terminal 100 cannot access the server device due to a communication failure or the like. Therefore, in a case where the server device is configured to store the gait authentication information 104b, the mobile terminal 100 may store at least a part of the gait authentication information 104b, and in a case where access to the server device is not possible, the mobile terminal 100 may perform the personal authentication using the at least a part of the gait authentication information 104b.

In such a case, the generation unit 105b of the mobile terminal 100 causes the storage unit 104 included in the own device to store at least a part of the gait authentication information 104b. Then, when the authentication unit 105d of the mobile terminal 100 accepts a request for permission to execute a predetermined function from the current user, if access to the server device is not possible, personal authentication, in which the gait data of the current user is referred to the gait authentication information 104b stored in the storage unit 104 included in the own device, is performed. Then, the mobile terminal 100 performs subsequent processing on the basis of the authentication result.

Furthermore, in the embodiment of the present disclosure described above, the electronic payment at the automatic ticket gate 300 has been described as a main example, but the present disclosure can also be applied to electronic payment at the time of purchasing a product at a store. In such a case, it is possible to configure a so-called seamless electronic payment system in which the user completes the purchase of the product only by leaving the store when the user has a desired product by confirming the result of the position information and the result of the gait authentication and enabling the electronic payment without the register.

Furthermore, in the embodiment of the present disclosure described above, the gait authentication based on the gait data has been described as an example, but the gait data is an example of behavior data, and personal authentication based on behavior data other than the gait data may be combined. The behavior data other than the gait data is, for example, behavior data indicated by a routine motion, a gesture, or the like performed by the user carrying the mobile terminal 100. These actions are more desirable if they are performed almost unconsciously by the user on a daily basis and also be distinctive.

Further, among the processing described in the embodiments of the present disclosure described above, all or a part of the processing, described as automatic processing, can be performed manually, or all or a part of the processing, described as manual processing, can be performed automatically by a known method. In addition, the processing procedures, specific names, and information including various data and parameters indicated in the document and the drawings can be arbitrarily changed unless otherwise specified. For example, various types of information illustrated in the drawings are not limited to the illustrated information.

Furthermore, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in arbitrary units according to various loads, usage conditions, and the like.

Furthermore, the above-described embodiments of the present disclosure can be appropriately combined to the extent that the processing contents do not contradict each other. Furthermore, the order of each step illustrated in the sequence diagrams or the flowcharts of the present embodiment can be changed as appropriate.

### 4. HARDWARE CONFIGURATION

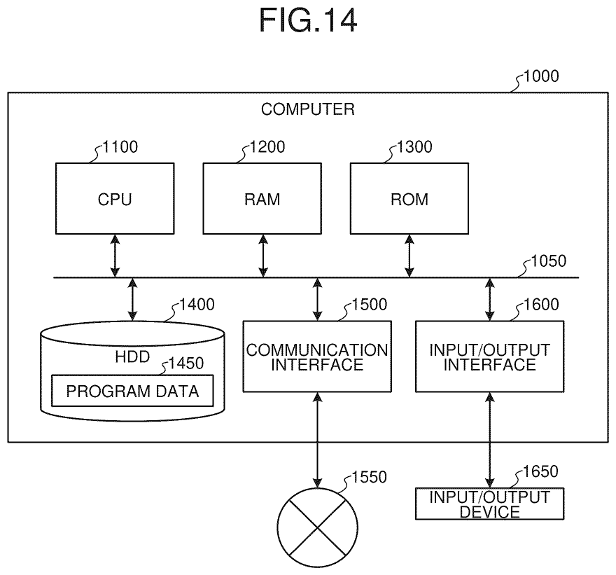

Furthermore, the mobile terminal 100 according to the above-described embodiments of the present disclosure is implemented by the computer 1000 having a configuration as illustrated in FIG. 14, for example. FIG. 14 is a hardware configuration diagram illustrating an example of the computer 1000 that implements functions of the mobile terminal 100. The computer 1000 includes a CPU 1100, a RAM 1200, a ROM 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 decompresses a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is started, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the embodiments of the present disclosure, which is an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the mobile terminal 100 according to the embodiments of the present disclosure, the CPU 1100 of the computer 1000 implements the functions of the control unit 105 by executing the program loaded on the RAM 1200. In addition, the HDD 1400 stores a program according to the present disclosure and data in the storage unit 104. Note that the CPU 1100 reads the program data 1450 from the HDD 1400 and executes the program data, but as another example, these programs may be acquired from another device via the external network 1550.

### 5. CONCLUSION

As described above, according to an embodiment of the present disclosure, the mobile terminal 100 is a mobile information processing apparatus and includes an acquisition unit 105a that acquires first behavior data indicating a behavior of an authorized user U-v and second behavior data indicating a behavior of a current user, and a function execution control unit 105e that stops execution of a predetermined function in a case where the current user is not authenticated as the authorized user U-v by personal authentication referring the second behavior data to personal authentication information of the authorized user U-v generated based on the first behavior data when an execution permission request for the predetermined function is accepted. This makes it possible to realize simpler personal authentication.

Although the embodiments of the present disclosure have been described above, the technical scope of the present disclosure is not limited to the embodiments described above as it is, and various modifications can be made without departing from the gist of the present disclosure. In addition, constituent elements of different embodiments and modifications may be appropriately combined.

Furthermore, the effects of the embodiments described in the present specification are merely examples and are not limited, and other effects may be provided.

Note that the present technology can also have the following configurations.

(1)

An information processing apparatus, which is a mobile information processing apparatus, comprising:
an acquisition unit that acquires first behavior data indicating a behavior of an authorized user and second behavior data indicating a behavior of a current user; and
a function execution control unit that stops execution of a predetermined function in a case where the current user is not authenticated as the authorized user by personal authentication referring the second behavior data to personal authentication information of the authorized user generated based on the first behavior data when an execution permission request for the predetermined function is accepted.
   (2)

The information processing apparatus according to (1), further comprising:
a generation unit that generates the personal authentication information based on the first behavior data and causes a storage unit included in an own device to store the personal authentication information; and
an authentication unit that performs the personal authentication when the execution permission request is accepted.
   (3)

The information processing apparatus according to (2), wherein
the first behavior data is gait data indicating a gait of the authorized user,
the second behavior data is gait data indicating a gait of the current user, and
the authentication unit performs the personal authentication by a gait authentication method.
   (4)

The information processing apparatus according to (1), (2), or (3), further comprising
an inertial sensor, wherein
the first behavior data and the second behavior data include at least sensor data of the inertial sensor.
   (5)

The information processing apparatus according to any one of (1) to (4), further comprising
a notification unit that notifies a notification destination registered in advance in a case where the current user is not authenticated as the authorized user.
   (6)

The information processing apparatus according to (5), wherein
the notification unit
notifies the notification destination of at least one of a fact that execution of the function has been stopped without the current user being authenticated as the authorized user and a current position.
   (7)

The information processing apparatus according to any one of (1) to (6), wherein
the function execution control unit
stops execution of the function executable from a lock screen only by the authorized user.
   (8)

The information processing apparatus according to any one of (1) to (7), further comprising
a monitoring unit that monitors whether there is a possibility that the current user is an unauthorized user based on the second behavior data.
   (9)

The information processing apparatus according to (8), wherein
the monitoring unit
inquires of the current user whether or not to add the personal authentication information in a case where there is a possibility that the current user is the unauthorized user, and when the current user is authenticated as the authorized user by an alternative authentication method, adds the personal authentication information based on the second behavior data.
   (10)

The information processing apparatus according to (1), further comprising:
a generation unit that transmits the first behavior data to a server device, causes the server device to generate the personal authentication information based on the first behavior data, and causes a storage unit included in the server device to store the personal authentication information; and
an authentication unit that transmits the second behavior data to the server device and causes the server device to perform the personal authentication when the execution permission request is accepted.
   (11)

The information processing apparatus according to (1), further comprising:
a generation unit that generates the personal authentication information based on the first behavior data, sends the personal authentication information to the server device, and causes a storage unit included in the server device to store the personal authentication information; and
an authentication unit that transmits the second behavior data to the server device and causes the server device to perform the personal authentication when the execution permission request is accepted.
   (12)

The information processing apparatus according to (10) or (11), wherein
the generation unit
causes a storage unit included in an own device to store at least part of the personal authentication information, and
the authentication unit
performs, when the execution permission request is accepted and access to the server device is not possible, the personal authentication referring the second behavior data to the personal authentication information stored in the storage unit included in the own device.
   (13)

An information processing method executed by a mobile information processing apparatus, comprising:
acquiring first behavior data indicating a behavior of an authorized user and second behavior data indicating a behavior of a current user; and
stopping execution of a predetermined function in a case where the current user is not authenticated as the authorized user by personal authentication referring the second behavior data to personal authentication information of the authorized user generated based on the first behavior data when an execution permission request for the predetermined function is accepted.
   (14)

A program causing a mobile computer to realize:
acquiring first behavior data indicating a behavior of an authorized user and second behavior data indicating a behavior of a current user; and
stopping execution of a predetermined function in a case where the current user is not authenticated as the authorized user by personal authentication referring the second behavior data to personal authentication information of the authorized user generated based on the first behavior data when an execution permission request for the predetermined function is accepted.

### REFERENCE SIGNS LIST

100 MOBILE TERMINAL
101 SENSOR UNIT
101a ACCELERATION SENSOR
101b GYRO SENSOR
101c GPS SENSOR
101d TOUCH SENSOR
101e CAMERA
102 HMI UNIT
103 COMMUNICATION UNIT
104 STORAGE UNIT
104a APPLICATION INFORMATION
104b GAIT AUTHENTICATION INFORMATION
104c ALTERNATIVE AUTHENTICATION INFORMATION
104d NOTIFICATION DESTINATION INFORMATION
105 CONTROL UNIT
105a ACQUISITION UNIT
105b GENERATION UNIT
105c MONITORING UNIT
105d AUTHENTICATION UNIT
105e FUNCTION EXECUTION CONTROL UNIT
105f NOTIFICATION UNIT
300 AUTOMATIC TICKET GATE
500 OTHER DEVICE
N NETWORK

1. An information processing apparatus, which is a mobile information processing apparatus, comprising:
an acquisition unit that acquires first behavior data indicating a behavior of an authorized user and second behavior data indicating a behavior of a current user; and
a function execution control unit that stops execution of a predetermined function in a case where the current user is not authenticated as the authorized user by personal authentication referring the second behavior data to personal authentication information of the authorized user generated based on the first behavior data when an execution permission request for the predetermined function is accepted.

2. The information processing apparatus according to claim 1, further comprising:
a generation unit that generates the personal authentication information based on the first behavior data and causes a storage unit included in an own device to store the personal authentication information; and
an authentication unit that performs the personal authentication when the execution permission request is accepted.

3. The information processing apparatus according to claim 2, wherein
the first behavior data is gait data indicating a gait of the authorized user,
the second behavior data is gait data indicating a gait of the current user, and
the authentication unit performs the personal authentication by a gait authentication method.

4. The information processing apparatus according to claim 1, further comprising
an inertial sensor, wherein
the first behavior data and the second behavior data include at least sensor data of the inertial sensor.

5. The information processing apparatus according to claim 1, further comprising
a notification unit that notifies a notification destination registered in advance in a case where the current user is not authenticated as the authorized user.

6. The information processing apparatus according to claim 5, wherein
the notification unit
notifies the notification destination of at least one of a fact that execution of the function has been stopped without the current user being authenticated as the authorized user and a current position.

7. The information processing apparatus according to claim 1, wherein
the function execution control unit
stops execution of the function executable from a lock screen only by the authorized user.

8. The information processing apparatus according to claim 1, further comprising
a monitoring unit that monitors whether there is a possibility that the current user is an unauthorized user based on the second behavior data.

9. The information processing apparatus according to claim 8, wherein
the monitoring unit
inquires of the current user whether or not to add the personal authentication information in a case where there is a possibility that the current user is the unauthorized user, and when the current user is authenticated as the authorized user by an alternative authentication method, adds the personal authentication information based on the second behavior data.

10. The information processing apparatus according to claim 1, further comprising:
a generation unit that transmits the first behavior data to a server device, causes the server device to generate the personal authentication information based on the first behavior data, and causes a storage unit included in the server device to store the personal authentication information; and
an authentication unit that transmits the second behavior data to the server device and causes the server device to perform the personal authentication when the execution permission request is accepted.

11. The information processing apparatus according to claim 1, further comprising:
a generation unit that generates the personal authentication information based on the first behavior data, sends the personal authentication information to the server device, and causes a storage unit included in the server device to store the personal authentication information; and
an authentication unit that transmits the second behavior data to the server device and causes the server device to perform the personal authentication when the execution permission request is accepted.

12. The information processing apparatus according to claim 10, wherein
the generation unit
causes a storage unit included in an own device to store at least part of the personal authentication information, and
the authentication unit
performs, when the execution permission request is accepted and access to the server device is not possible, the personal authentication referring the second behavior data to the personal authentication information stored in the storage unit included in the own device.

13. An information processing method executed by a mobile information processing apparatus, comprising:
acquiring first behavior data indicating a behavior of an authorized user and second behavior data indicating a behavior of a current user; and
stopping execution of a predetermined function in a case where the current user is not authenticated as the authorized user by personal authentication referring the second behavior data to personal authentication information of the authorized user generated based on the first behavior data when an execution permission request for the predetermined function is accepted.

14. A program causing a mobile computer to realize:
acquiring first behavior data indicating a behavior of an authorized user and second behavior data indicating a behavior of a current user; and
stopping execution of a predetermined function in a case where the current user is not authenticated as the authorized user by personal authentication referring the second behavior data to personal authentication information of the authorized user generated based on the first behavior data when an execution permission request for the predetermined function is accepted.
